(19) United States
(12) Patent Application Publication
(10) Pub. No.: US 2019/0375392 A1
(43) Pub. Date: Dec. 12, 2019

(54) DEVICE AND METHOD FOR CONTROLLING A VEHICLE AND VEHICLE

(71) Applicant: ZF Friedrichshafen AG, Friedrichshafen (DE)

(72) Inventors: Ludger RAKE, Steinfeld (DE); Hendrik LOTTER, Melle (DE)

(73) Assignee: ZF Friedrichshafen AG, Friedrichshafen (DE)

(21) Appl. No.: 16/485,285

(22) PCT Filed: Jan. 15, 2018
(86) PCT No.: PCT/EP2018/050821

§ 371 Date: Aug. 12, 2019

(30) Foreign Application Priority Data
Feb. 15, 2017 (DE) 10 2017 202 437.2

(51) Int. Cl. B60W 10/20; B60W 50/08

(52) U.S. Cl. CPC B60W 10/20; B62D 1/12; B60W 50/08

(57) ABSTRACT

The invention relates to a device for controlling a vehicle that comprises an operating component that can be moved by an operator of the vehicle, and a sensor device for providing a status signal that represents a position of the operating component and a movement signal that represents a movement of the operating component. The device also comprises a control device that is configured to provide a steering signal for actuating a steering mechanism in the vehicle based on the movement signal, when the status signal indicates a position of the operating component that is assigned to a forward driving mode of the vehicle.

The present invention relates to a device and a method for controlling a vehicle, and a vehicle.

Vehicles have steering wheels and gearshift levers. The direction of travel of a vehicle can be altered with the steering wheel. A driving mode and/or drive position of the vehicle can be selected with the gearshift lever, in particular with automatic and/or stepless transmissions.

Based on this, the present invention creates an improved device and an improved method for controlling a vehicle, and an improved vehicle, according to the independent claims. Advantageous embodiments can be derived from the dependent claims and the following description.

Operating components for selecting a driving mode of a vehicle, e.g. in the form of a gearshift lever, can also advantageously be used for steering the vehicle when the vehicle is travelling forwards. The operating component according to one embodiment can also be used for steering the vehicle when the vehicle is travelling quickly, e.g. at more than 30 km/h or more than 50 km/h.

A device for controlling a vehicle has an operating component that can be moved by an operator of the vehicle, a sensor device for obtaining a status signal representing a position of the operating component, and a movement signal representing a movement of the operating component. The device also has a control device, which is configured to provide a steering signal from the movement signal for actuating a steering mechanism in the vehicle, when the status signal indicates a position of the operating component assigned to a forward driving mode of the vehicle.

A position of the operating component can be understood to be a status of the operating component that has been selected. By way of example, a monostable gearshift lever can have various positions that can be selected by moving it in one or more directions.

The vehicle is a vehicle for transporting people, or a utility vehicle. The vehicle can be powered by an internal combustion engine or an electric drive. This can be an autonomous, semi-autonomous, or manually controlled vehicle. The operator can be the driver of the vehicle. The moving operating component can be located in a control panel or console in the vehicle. The operating component can be actuated by a hand of the operator. The operating component can be moved back and forth between different positions by an actuation thereof. By way of example, each position can be assigned to a driving mode. The movement of the operating component can comprise an additional actuation, in which the operating component is not switched back and forth between the different positions. The sensor device can comprise one or more sensors, with which both the different positions of the operating component as well as the movement of the operating component can be detected. The control device can be an electric circuit that is configured to input and use the status signal and the movement signal for obtaining the steering signal. The control device can thus be configured to process electric signals and output control signals on the basis thereof. The device can have one or more interfaces in the form of hardware or software. Hardware interfaces can be part of an integrated circuit, for example, in which functions of the device are implemented. These interfaces can also be individual integrated circuits, or at least partially composed of discrete components. Software interfaces can be software modules, in addition to other software modules, on a microcontroller. The steering mechanism can be coupled to the wheels of a vehicle that can be steered in order to change the direction of travel of the vehicle.

The control device can be configured to provide a selection signal for selection a driving mode of the vehicle based on the status signal. Possible driving modes represent, e.g., forwards travel, reverse travel, neutral, park, or different gear ratios. Advantageously, the operator can thus use the device for selecting a desired driving mode.

The control device can be configured, e.g., to provide the selection signal to an interface for a transmission in the vehicle. In this case, the control device can be used for selecting a gear.

By way of example, the control device can be configured to provide a first selection signal for selecting the forward driving mode when the status signal represents a first position of the operating component. The control device can also be configured to provide a second selection signal for selecting a reverse driving mode of the vehicle when the status signal represents a second position of the operating component. The device can be used in this manner to shift the vehicle to an operating mode in which the vehicle travels forwards, as well as to an operating mode in which the vehicle travels in reverse.

The control device can be configured to provide the steering signal for actuating the steering mechanism in the vehicle based on the movement signal when the status signal represents the first position of the operating component, as well as when the status signal represents the second position of the operating component. The operator can steer the vehicle using the operating component in this manner in both forward travel as well as reverse travel.

The control device can be configured to determine the steering signal from the movement signal using a first translation rule when a speed signal represents a first driving speed of the vehicle. Accordingly, the control device can be configured to determine the steering signal from the movement signal using a second translation rule when the speed signal represents a second driving speed of the vehicle. The second driving speed can be greater than the first driving speed. A value of the movement signal can be translated to a value of the steering signal by a translation rule. A steering characteristic can thus be mapped by the translation rule. By way of example, a translation rule can be obtained from a characteristic, a function, or a reference table. A single movement signal can be translated to different steering signals by different translation rules. In this manner, the response behavior of the steering system can be adapted to different speeds of the vehicle.

According to one embodiment, the first driving speed can represent a speed of less than 50 km/h, and the second driving speed can represent a speed of more than 50 km/h. As a result, the vehicle can exhibit a different steering behavior at speeds of less than 50 km/h than at speeds of more than 50 km/h.

The sensor device can be configured to provide a position signal representing a further position and/or further movement of the operating component. In this case, the control device can be configured to provide an acceleration signal for actuating an acceleration mechanism in the vehicle based on the position signal. The operating component can thus also be used for accelerating and slowing the vehicle.

By way of example, the control device can be configured to provide a first acceleration signal to an interface for an electric drive of the vehicle when the position signal represents a first further position and/or first further movement of the operating component. Additionally or alternatively, the control device can be configured to provide a second acceleration signal to an interface for a recuperative braking device in the vehicle when the position signal represents a second further position and/or second further movement of the operating component. The device can thus be advantageously used in conjunction with an electric vehicle.

By way of example, the operating component can be in the form of a joystick. Such an operating component takes up little space, and can be operated intuitively.

The sensor device can be configured to provide a touch signal representing a touching of the operating component by a hand of the operator. As a result, it can be determined whether a hand of the operator rests on the operating component. The sensor device can also be configured to identify the touch of the operator, and to distinguish between the touch of the operator and the touch of another passenger. The identification of the touch of an operator can be based, for example, on a biometric comparison.

The control device can be configured to provide an actuating signal representing an actuation of a button on the operating component. In this case, the control device can be configured to provide a shifting signal to an interface for a switching device for switching between a manual and an automatic operating mode of the vehicle using the actuating signal. By way of example, the button can be actuated when the operator is ready to assume control of the vehicle, or wants to relinquish control.

The operating component can be designed to be moved along a first movement path, in order to assume different positions. Additionally or alternatively, the operating component can be designed to be moved along a second movement path. The operating component can thus be moved along different movement paths for selecting a desired driving mode, and steering the vehicle. Advantageously, the driving mode can be selected and the vehicle can be steered with a single operating component.

The operating component can have a base element and an operating element. The base element can be designed to be moved along a first movement path in order to assume the different positions. The operating element can be designed to be moved in relation to the base element. The operating element can be attached to the base element such that it can be displaced or rotated. The operating possibilities can thus be increased by the operating element.

A corresponding vehicle can have a steering mechanism and the specified device. The device and the steering mechanism can be coupled to one another via an interface for the steering signal. The steering mechanism is configured to alter the direction of travel of the vehicle based on the steering signal.

A corresponding method for controlling a vehicle comprises the following steps:

providing a status signal representing a position to which an operating component can be moved by an operator of the vehicle;

providing a movement signal representing a movement of the operating component; and

providing a steering signal for actuating a steering mechanism in the vehicle based on the movement signal when the status signal indicates a position of the operating component assigned to a forward driving mode of the vehicle.

The steps of the method can be executed using the specified device.

The invention shall be explained by way of example in greater detail based on the attached drawings. Therein:

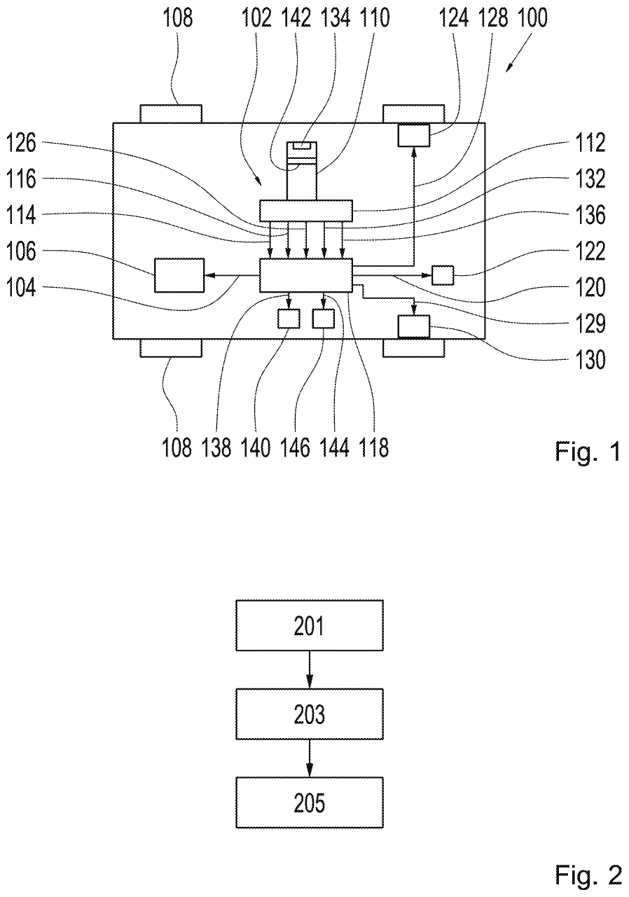

FIG. 1 shows a schematic illustration of a vehicle according to an exemplary embodiment;

FIG. 2 shows a flow chart for a method for controlling a vehicle according to an exemplary embodiment;

FIG. 3 shows a device for controlling a vehicle according to an exemplary embodiment;

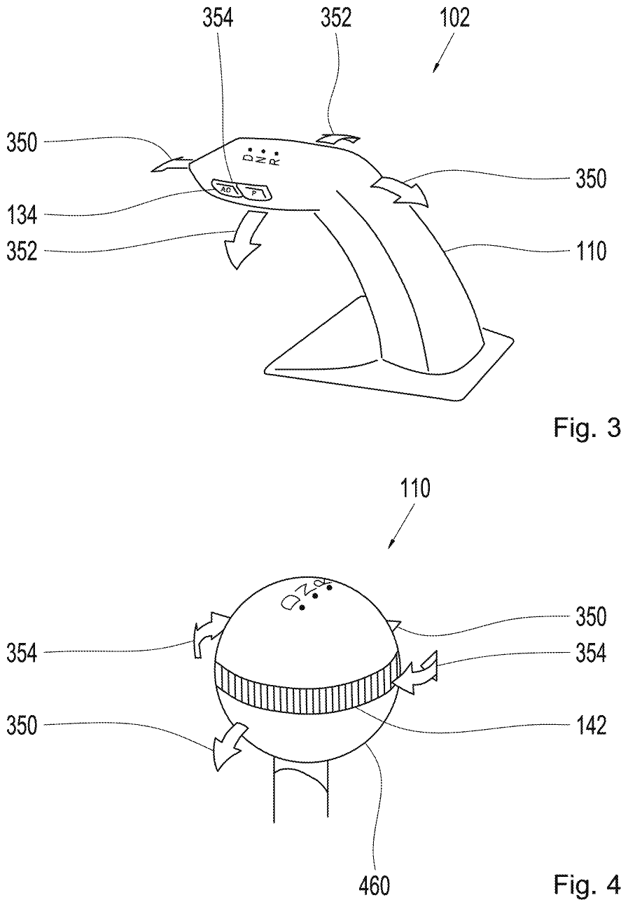

FIG. 4 shows an operating component of a device for controlling a vehicle according to an exemplary embodiment; and

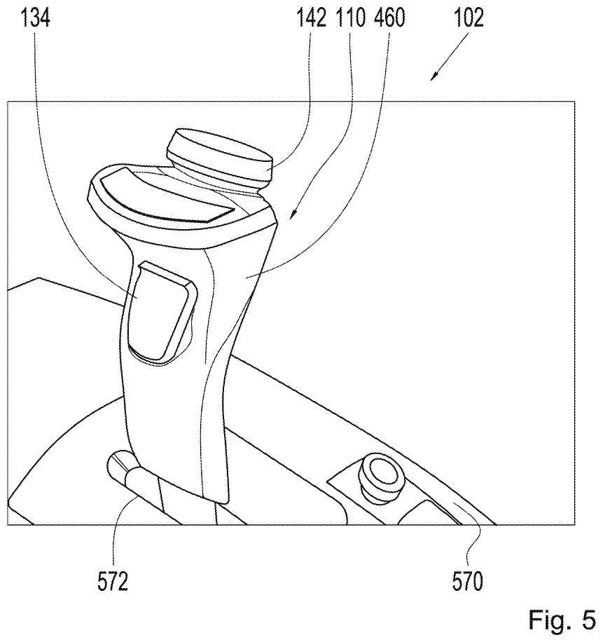

FIG. 5 shows a device for controlling a vehicle according to an exemplary embodiment.

In the following description of preferred exemplary embodiments of the present invention, the same or similar reference symbols are used for the elements shown in the figures that have similar functions, wherein the descriptions of these elements shall not be repeated.

FIG. 1 shows a schematic illustration of a vehicle 100 according to an exemplary embodiment. The vehicle 100 has a device 102 for controlling the vehicle 100. By way of example, the vehicle 100 is a vehicle for conveying people. The vehicle 100 can be steered, among other things, using the device 102. The device 102 can also be used for steering the vehicle 100, in particular at high speeds, exceeding speeds for residential areas. In order to steer the vehicle 100, the device 102 is configured to provide a steering signal 104 to the steering mechanism 106 of the vehicle 100. According to one exemplary embodiment, the steering mechanism 106 has an actuator that is configured to alter the position of steerable wheels 108 of the vehicle 100 when it is actuated by the steering signal 104. In this manner, the direction of travel of the vehicle 100 can be altered.

The device 102 has an operating component 110 that can be operated by an operator while driving the vehicle 100. By way of example, the operating component 110 is in the form of a lever or joystick. The operating component 110 is attached, e.g. to a control panel of the vehicle 100 such that it can move. The operating component 110 can be moved to different positions when actuated. According to one exemplary embodiment, each of the positions is assigned to a driving mode of the vehicle 100. By way of example, there are at least two different positions, one of which is for a forward driving mode and one of which is for a reverse driving mode. In the forward setting, the vehicle 100 is in a mode in which is travels forwards. In the reverse setting, the vehicle 100 is in a mode in which it travels backwards. The operating component 110 can also be moved along an additional movement path. A movement of the operating component 110 along the additional movement path can be translated to the steering signal 104 in the device 102. In this manner, the function of a steering wheel for the vehicle 100 can be obtained with the operating component 110. A complete steering functionality can thus be obtained with the use of the device 102, by means of which the vehicle 100 can be steered by the operator, even at higher speeds, e.g. at speeds of more than 50 km/h.

The device 102 comprises a sensor device 112 that is configured to detect a current position of the operating component 110 and a current movement of the operating component 110 along the additional movement path. The sensor device 112 is configured to provide a status signal 114 that indicates a current position of the operating component 110. The sensor device 112 is also configured to provide a movement signal 116 that indicates a current movement of the operating component 110 along the additional movement path. For this, the sensor device 112 has numerous sensors according to one exemplary embodiment.

The device 102 also comprises a control device 118. The control device 118 is configured to input the status signal 114 and the movement signal 116. The device 102 is configured to determine the steering signal 104 based on the movement signal, and provide it to the steering mechanism 106 at an interface. According to one embodiment, the control device 118 is configured to map a curve or value of the movement signal 116 on the steering signal 104.

The control device 118 is configured to provide the steering signal 104 based on the movement signal 116 when the status signal 114 indicates that the operating component 110 is in a position assigned to forward travel of the vehicle 100. In this manner, the steering functionality can be activated in response to a selection of the forward driving mode. According to one exemplary embodiment, the control device 118 is also configured to provide the steering signal 104 based on the movement signal 116 when the status signal 114 indicates that the operating component 110 is in a position assigned to a reverse driving mode of the vehicle 100.

According to one exemplary embodiment, the control device 118 is configured to provide a selection signal 120 to an interface for a driving mode selection device 122, e.g. a transmission in the vehicle 100 or an actuator for an electric motor 124 in the vehicle 100, based on the status signal 114. A driving mode of the vehicle 100 can be set using the selection signal 120. This can take place, for example, by selecting a suitable gear, or driving mode, or by selecting a suitable voltage for operating the electric motor 124. The control device 118 according to one exemplary embodiment is configured to provide the selection signal 120 with a first value, by means of which the driving mode selection device 122 is actuated such that the vehicle travels in a forward direction. The selection signal 120 with the first value is then provided when the operating component 110 is in a first position that is assigned to the forward driving mode. Accordingly, the control device 118 is also configured to provide the selection signal 120 with a second value, by means of which the driving mode selection device 122 is actuated such that the vehicle 100 travels backwards. The selection signal 120 with the second value is then provided when the operating component 110 is in a second position that is assigned to the reverse driving mode.

According to one exemplary embodiment, the control device 118 is configured to only provide the steering signal 104 when the operating component 110 is in a position assigned to a forward driving mode. According to one exemplary embodiment, the control device 118 is also configured to also provide the steering signal when the operating component 110 is in a position assigned to a reverse driving mode.

According to one exemplary embodiment, the control device 118 is configured to determine the steering signal 104 from the movement signal, based on a translation rule. According to one exemplary embodiment, the translation rule defines which steering angle change to the wheels 108 is caused by a specific movement of the operating component 110 along the additional movement path. According to one exemplary embodiment, there are different translation rules for each speed interval. In this manner, the steering behavior of the vehicle 100 can be adapted to a current speed of the vehicle 100. By way of example, the sensor device 118 is configured to determine the steering signal 104 based on a first translation rule when the speed of the vehicle 100 is in a first interval, and to determine the steering signal 104 based on a second translation rule that differs from the first translation rule when the speed of the vehicle 100 is in a second interval that differs from the first interval. By way of example, there is a threshold value between the two translations rules at 1 km/h, 30 km/h, 50 km/h or 100 km/h. There can also be more than two speed intervals and more than two translation rules for determining the steering signal 104.

According to one exemplary embodiment, the control device 118 is configured to input a speed signal 144 that represents a current driving speed of the vehicle 100. By way of example, the control device 118 is configured to input the speed signal 144 to a speed detection device 146 via an interface. The control device 118 is configured to select a translation rule assigned to a driving speed indicated by the speed signal 114, based on the speed signal 144.

According to one exemplary embodiment, the operating component 110 is also used for accelerating. An acceleration can be understood to mean both an increase in speed as well as a reduction in speed. In this case, the sensor device 112 is configured to provide a position signal 126 that indicates a further position and/or further movement of the operating component 110. The further movement or further position can be obtained in that the operating component 110 is moved by the operator along a further movement path that is not used for selecting the positions for the driving modes, nor for executing the movement for steering the vehicle 100. In this case, the control device is configured to determine the position signal 126 based on at least one acceleration signal 128, 129. The control device 118 is configured to send the acceleration signal 128, 129 to an interface for an acceleration device in the vehicle 100. By way of example, the control device 118 is configured to send an acceleration signal 128 to the drive 124 of the vehicle 100 in order to increase the speed of the vehicle when the position signal indicates that the operating component 110 has been moved to a position, or is moved in a manner, that is assigned to increasing speed. The control unit 118 is accordingly configured, e.g. to send an acceleration signal 120 for reducing the speed of the vehicle 100 to a braking mechanism 130 of the vehicle 100 when the position signal 126 indicates that the operating component 110 has been move to a position, or is moved in a manner, that is assigned to reducing speed. The braking mechanism 130 can be a mechanical brake or a recuperative braking mechanism.

According to one exemplary embodiment, the sensor device 112 is configured to detect a touching of the operating component 110 by a hand of the operator. For this, the sensor device 112 can comprise a capacitive sensor. The sensor device 112 is configured to provide a touch signal 132 in response to touching the operating component 110 that indicates the touch.

According to one exemplary embodiment, there is a button 134 on the operating component 110. The sensor device 112 is configured to detect an actuation of the button 134, and to provide an actuation signal in response to a detected actuation of the button 134. The control device 118 is configured to input the actuation signal 136 and to provide a switching signal 138 to an interface for a switching device 140 for switching between a manual and an automatic operating mode of the vehicle 100 based on the actuation signal 136. This enables the driver of the vehicle 100 to assume or relinquish control of the vehicle 100 by actuating the button 134.

The operating component 110 is shaped such that it enables the driver of the vehicle 100 to readily operate the operating component 110. According to one exemplary embodiment, the operating component 110 can be moved. For this, there are different movement paths along which the operating component 110 can be moved. According to one exemplary embodiment, a first movement path is defined, along which the operating component 110 can be actuated or moved in order to assume the different positions assigned to different driving states. For this, the operating component 110 can be actuated in the manner of a known gearshift lever. In order to move the operating component 110 to steer the vehicle 100, the operating component 110 can move along a second movement path according to one exemplary embodiment. At least one of the movement paths is defined by a shiftgate in which the operating component 110 can be moved according to one exemplary embodiment. Further movement paths can be defined for implementing further functionalities. By way of example, a movement path can be defined for accelerating the vehicle 100, along which the operating component 110 can be moved.

According to one exemplary embodiment, the operating component 110 has a base element and an operating element 142. The operating element 142 can move in relation to the base element, and is attached to the base element. The sensor device 112 is configured to map the different positions of the operating component 110 through the status signal 114 in this exemplary embodiment, and detect a movement of the operating element 142 in relation to the base element, and map it through the movement signal 116.

FIG. 2 shows a flow chart for a method for controlling a vehicle according to an exemplary embodiment. The method can be executed using the device shown in FIG. 1.

A selection signal is provided in step 201 that represents a position of an operating component that can be moved by an operator of the vehicle. A movement signal is provided in step 203 that represents a movement of the operating component. A steering signal is provide in step 205, based on the movement signal, which can actuate a steering mechanism of the vehicle. The steering signal is provided when the status signal indicates a position of the operating component assigned to a forward driving mode of the vehicle. The steps 201, 203, 205 of the method can be repeated continuously, and carried out in different sequences.

FIG. 3 shows a device 102 for controlling a vehicle according to an exemplary embodiment. This can be an exemplary embodiment of the device described in reference to FIG. 1.

The device 102 has an operating component 110 that can be moved along a first movement path 350 and along a second movement path 352.

The first movement path 350 is assigned to a selection actuation through which an operator can select different driving modes. According to this exemplary embodiment, there are three driving modes, “D,” “N,” and “R,” each of which is assigned a position of the operating component 110. A desired driving mode can be selected by actuating the operating component 110 along the first movement path 350, in that the operating component 110 is moved by the actuation to the position assigned to the desired driving mode.

The second movement path 352 is assigned to a steering actuation, through which the operator can steer the vehicle. By way of example, an actuation of the operating component 110 along the second movement path 352 in a first direction can be translated to a first direction in a first steering movement of the vehicle. Accordingly, a movement of the operating component 110 along the second movement path 352 in a second direction, opposite the first direction, can be translated to a second steering movement of the vehicle.

According to this exemplary embodiment, the operating component 110 has a shaft, or gearshift lever, that can be moved in an element of the vehicle, and an extension or knob at an angle to the exposed end of the shaft or gearshift lever. There are two buttons 134, 354 in the extension or knob, according to this exemplary embodiment.

According to one exemplary embodiment, the device 102 represents an integration of functions, in which the operating component 110 in the form of a steering joystick is integrated in a gearshift lever. In this manner, a gearshift lever is obtained in the form of a joystick combined with a steering mechanism.

The approach described in reference to the figures can be used, e.g., in a vehicle that is automated to a higher extent. A permanent steering is no longer necessary with vehicles that have a higher degree of automation. These vehicle concepts frequently no longer have a conventional steering wheel, and can also be equipped with separate steering joysticks, or the like. The approach described herein enables an integration of the operating element “steer-by-wire” steering in the selection actuation 350 that can be executed with the operating component 110.

The integration of an operating element for steering a vehicle in a gearshift lever actuation has numerous advantages. This enables an integration of functions in an existing component for selection actuation 350. An ergonomic configuration is obtained in the vehicle. This also reduces the number of operating elements. Driving safety is improved when assuming driving tasks in critical situations by the quick availability of the operating component 110, e.g. in the form of a joystick. The driving safety is also increased by the optional integration of the hands-on detection in the operating component 110. Furthermore, it is possible to integrate a button 134 in the joystick, in the form of a transfer button for AD (autonomous driving). An intuitive operation of the steer-by-wire steering is also obtained. Optionally, different steering characteristics can be depicted based on the speed, e.g. depending on whether the vehicle is being driven on the highway, or is moving at slower speeds.

The operating element for steering the vehicle can be integrated in the device used for selection actuation 350. This can be obtained, e.g. with the operating component 110 in the form of a central joystick, in which the functionality of a gearshift lever is assigned to a movement of the operating component 110 along the x-axis, and the functionality of a steering wheel is assigned to a movement of the operating component 110 along the y-axis.

Variations can also be obtained in conjunction with a rotary shifter.

The approach described herein is based on an integration of a steering function in a gearshift lever, shown in FIG. 3 as the operating component 110. Alternatively, the operating component 110 can be divided into a base element and at least one operating element, as shown in FIG. 4. According to one exemplary embodiment, the operating component can also be used to accelerate and slow the vehicle, in addition to selecting a driving mode and providing the steering function. As a result, a “gas pedal” function and a “brake pedal” function is also provided by the operating component 110. An electric drive forms the basis for the acceleration. The braking can be recuperative. The steering function can be carried out in particular when the vehicle is in an operating state for forward travel.

FIG. 4 shows an operating component 110 of a device for controlling a vehicle according to an exemplary embodiment. This can be an exemplary embodiment of the device described in reference to FIG. 1. The operating component 110 has a base element 460 with a shaft or gearshift lever supporting a ball, and an operating element 142. The base element 460 can be moved along a first movement path 350, to which the functionality of a gearshift lever actuation is assigned, as described in reference to FIG. 3. The operating element 142 can move in relation to the base element 460. According to this exemplary embodiment, the operating element 142 is annular, encompassing the ball-shaped base element 460. The operating element 142 can be rotated along the second movement path 354. The functionality of a steering actuation, as described in reference to FIG. 3, is assigned to a rotational movement of the base element 460.

According to one exemplary embodiment, the operating component 110 represents an integration of functions in which the base element 460 in the form of a gearshift lever is combined with the operating element 142 serving as a steering wheel.

FIG. 5 shows a device for controlling a vehicle according to an exemplary embodiment. This can be an exemplary embodiment of the device described in reference to FIG. 1. The device 102 has an operating component 110, comprising a base element 460 and an operating element 142. There is a button 130 on the base element 460. The operating component 110 can be moved along a first movement path in a console 570 in the vehicle. The first movement path is defined by a shiftgate 572 with straight slots, by way of example, along which the operating component 110 can be moved. The operating component 110 can be moved to different positions assigned to the various driving modes, “P,” “R,” “N,” “D,” and “S,” by moving the operating component 110 along the first movement path. The operating element 142 is attached to an upper surface of the base element 460 in the form of a rotary knob. The operating element can be moved along a second movement path, in this case a circular path. The operator can steer the vehicle by moving the operating element 142.

According to one exemplary embodiment, a steering signal representing a rotation of the operating element 142 is provided when the operating component 110 is in a position assigned to one of the driving modes, “N,” “D,” or “S.” According to another exemplary embodiment, the steering signal is also provided when the operating component 110 is in a position assigned to the driving mode “R.”

According to one exemplary embodiment, the device 102 represents an integration of functions in which the base element 460 in the form of a steering joystick is combined with the operating element 142 in the form of a rotatronic, wherein the rotatronic is used for selecting the various driving modes, “P, R, N, D, S.”

If an exemplary embodiment comprises an “and/or” conjunction between a first feature and a second feature, this can be read to mean that the exemplary embodiment according to one embodiment contains both the first feature and the second feature, and according to another embodiment, contains either just the first feature or just the second feature.

### REFERENCE SYMBOLS

100 vehicle
102 device
104 steering signal
106 steering mechanism
108 wheels
110 base element
112 sensor
114 status signal
116 movement signal
118 control device
120 selection signal
122 driving mode selection device
124 drive
126 position signal
128 acceleration signal
129 acceleration signal
130 brake mechanism
132 touch signal
134 button
136 actuation signal
138 switching signal
140 switching device
142 operating element
144 speed signal
146 speed detection device
201 step for providing a status signal
203 step for providing a movement signal
205 step for providing a steering signal
350 first movement path
352 second movement path
354 button
460 base element
570 console
572 shiftgate

1. A device for controlling a vehicle, wherein the device comprises an operating component that can be moved by an operator of the vehicle, and a sensor device or providing a status signal that represents a position of the operating component and a movement signal that represents a movement of the operating component, wherein the device comprises a control device that is configured to provide a steering signal for actuating a steering mechanism in the vehicle based on the movement signal when the status signal indicates a position of the operating component that is assigned to a forward driving mode of the vehicle.

2. The device according to claim 1, wherein the control device is configured to provide a selection signal for selecting a driving mode of the vehicle.

3. The device according to claim 2, wherein the control device is configured to provide a first selection signal for selecting a forward driving mode when the status signal represents a first position of the operating component, and to provide a second selection signal for selecting a reverse driving mode of the vehicle when the status signal represents a second position of the operating component.

4. The device according to claim 3, wherein the control device is configured to provide the steering signal for actuating a steering mechanism of the vehicle based on the movement signal when the status signal represents the first position of the operating component, as well as when the status signal represents the second position of the operating component.

5. The device according to claim 1, wherein the control device is configured to determine the steering signal from the movement signal based on a first translation rule when a speed signal represents a first driving speed of the vehicle, and to determine the steering signal from the movement signal based on a second translation rule when the speed signal represents a second driving speed of the vehicle.

6. The device according to claim 5, wherein the first driving speed represents a speed of less than 50 km/h, and the second driving speed represents a speed of more than 50 km/h.

7. The device according to claim 1, wherein the sensor device is configured to provide a position signal that represents a further position and/or further movement of the operating component, and the control device is configured to provide an acceleration signal for actuating an acceleration mechanism in the vehicle based on the position signal.

8. The device according to claim 7, wherein the control device is configured to provide a first acceleration signal to an interface to an electric drive of the vehicle when the position signal represents a first further position and/or a first further movement of the operating component, and/or to provide a second acceleration signal to an interface to a recuperative braking mechanism of the vehicle when the position signal represents a second further position and/or second further movement of the operating component.

9. The device according to claim 1, wherein the operating component is in the form of a joystick.

10. The device according to claim 1, wherein the sensor device is configured to provide a touch signal representing a touching of the operating component by a hand of the operator.

11. The device according to claim 1, wherein the sensor device is configured to provide an actuation signal representing an actuation of a button on the operating component, and the control device is configured to provide a switching signal to an interface for a switching mechanism for switching between a manual and autonomous operating mode of the vehicle based on the actuation signal.

12. The device according to claim 1, wherein the operating component is designed such that it can assume different positions along a first movement path, and/or such that it can be moved along a second movement path.

13. The device according to claim 1, wherein the operating component comprises a base element and an operating element, wherein the base element is designed to assume the different positions along a first movement path, and wherein the operating element is designed to move in relation to the base element.

14. A vehicle with a steering mechanism and a device according to claim 1, wherein the device and the steering mechanism are coupled to one another via an interface for transmitting the steering signal, and the steering mechanism is configured to change the direction of travel of the vehicle based on the steering signal.

15. A method for controlling a vehicle that comprises the following steps:
providing a status signal that represents a position of an operating component that can be moved by an operator of the vehicle;
providing a movement signal that represents a movement of the operating component; and
providing a steering signal for actuating a steering mechanism in the vehicle based on the movement signal when the status signal indicates a position of the operating component that is assigned to a forward driving mode of the vehicle.
